(19) United States
(12) Patent Application Publication
(10) Pub. No.: US 2022/0272252 A1
(43) Pub. Date: Aug. 25, 2022

(54) IMAGING APPARATUS, METHOD FOR REDUCING COLOR UNEVENNESS DUE TO FLICKER, AND COMPUTER READABLE RECORDING MEDIUM

(71) Applicant: Olympus Corporation, Tokyo (JP)

(72) Inventor: Masatoshi NODA, Tokyo (JP)

(73) Assignee: Olympus Corporation, Tokyo (JP)

(21) Appl. No.: 17/740,197

(22) Filed: May 9, 2022

Related U.S. Application Data
(63) Continuation of application No. PCT/JP2019/044945, filed on Nov. 15, 2019.

(51) Int. Cl. H04N 5/235

(52) U.S. Cl. CPC H04N 5/2357; H04N 5/2352

(57) ABSTRACT

An imaging apparatus includes: a processor configured to detect a flicker cycle of a light source; generate a difference image between an image in which a light intensity fringe is not present and an image in which a light intensity fringe is present based on the flicker cycle; divide the difference image into a plurality of regions; identify a first color unevenness occurrence region, a second color unevenness occurrence region, and a color unevenness non-occurrence region; determine a center position of an exposure period in the identified color unevenness non-occurrence region, and controls exposure; and control exposure such that, in a direction perpendicular to an image reading direction of an image sensor, the center position of the exposure period located in the color unevenness non-occurrence region satisfying predetermined conditions.

This application is a continuation of International Application No. PCT/JP2019/044945, filed on Nov. 15, 2019, the entire contents of which are incorporated herein by reference.

### BACKGROUND

The present disclosure relates to an imaging apparatus, a method for reducing color unevenness, and a computer readable recording medium.

In recent years, with respect to an imaging apparatus, such as a digital camera, a technique for adjusting an image capturing timing such that a timing at which light intensity of a flicker light source has a maximum value coincides with an imaging timing has been known (see Japanese Patent No. 6220225). In this technique, a timing at which variation in flicker light intensity is small is detected based on a first image in which exposure unevenness has occurred due to flicker of the light source, and a second image is captured at the detected timing to reduce an influence of the flicker on exposure of a still image.

### SUMMARY

An imaging apparatus according to one aspect of the present disclosure may include a processor configured to: detect a flicker cycle of a light source from an incident light that enters an image sensor used for multi-zone metering; generate a difference image between an image in which a light intensity fringe is not present and an image in which a light intensity fringe is present based on the flicker cycle; divide the difference image into a plurality of regions along an image reading direction of the image sensor; identify, from among the plurality of divided regions, a first color unevenness occurrence region including a portion in which a light intensity waveform decreases, a second color unevenness occurrence region including a portion in which the light intensity waveform decreases, and a color unevenness non-occurrence region in which the light intensity waveform increases from the first color unevenness occurrence region to the second color unevenness occurrence region; determine a center position of an exposure period in the identified color unevenness non-occurrence region, and controls exposure; and control exposure such that, in a direction perpendicular to an image reading direction of an image sensor, the center position of the exposure period located in the color unevenness non-occurrence region satisfying conditions 1 to 3 below: condition 1: located at a position at which the exposure period does not include the first color unevenness occurrence region and the second color unevenness occurrence region at time of exposure; condition 2: located at a position that does not include a minimum light intensity position at a side of the first color unevenness occurrence region in the color unevenness non-occurrence region; and condition 3: located at a position that does not include a peak intensity position at a side of the second color unevenness occurrence region in the color unevenness non-occurrence region.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating a functional configuration of an imaging apparatus according to an embodiment;

FIG. 2 is a diagram schematically illustrating an image that is obtained when flicker occurs;

FIG. 3 is a diagram schematically illustrating a luminance value at each of positions divided for each of regions in a vertical direction in the image in FIG. 2;

FIG. 4 is a diagram for schematically explaining one example of a case in which imaging is performed such that a center of an exposure period coincides with a timing of a peak of a flicker waveform according to the known technique;

FIG. 5 is a flowchart illustrating an outline of a process performed by the imaging apparatus according to the embodiment;

FIG. 6 is a diagram schematically illustrating a first live view image in which a flicker fringe is not present;

FIG. 7 is a diagram schematically illustrating a second live view image in which flicker fringes are present;

FIG. 8 is a diagram illustrating an image in which the flicker fringes are extracted;

FIG. 9 is a diagram schematically illustrating object luminance values By that are obtained by averaging object luminance values in each of metering regions for each of image reading directions;

FIG. 10 is a diagram for schematically explaining a center position of an exposure period that is determined by an exposure control unit;

FIG. 11 is a diagram for schematically explaining the center position of the exposure period that is determined by the exposure control unit;

FIG. 12 is a block diagram illustrating a functional configuration of an imaging apparatus according to an example;

FIG. 13 is a diagram schematically illustrating RGB output values at each of positions divided for each of regions in a direction perpendicular to the image reading direction in the image in FIG. 2;

FIG. 14 is a diagram schematically illustrating RGB output values at each of positions divided for each of regions in a direction perpendicular to the image reading direction in an image in which flicker is not present;

FIG. 15 is a diagram schematically illustrating RGB output values at each of positions divided for each of regions in a vertical direction in a difference image that is obtained by subtracting the image in FIG. 14 from the image in FIG. 13;

FIG. 16 is a flowchart illustrating an outline of a process performed by the imaging apparatus;

FIG. 17 is a diagram for schematically explaining a center position of an exposure period that is determined by an exposure control unit;

FIG. 18 is a diagram for schematically explaining a center position of an exposure period that is determined by an exposure control unit according to a first modification; and

FIG. 19 is a diagram for schematically explaining the center position of the exposure period that is determined by the exposure control unit.

### DETAILED DESCRIPTION

Modes (hereinafter, referred to as “embodiments”) for carrying out the present disclosure will be described below with reference to the drawings. The present disclosure is not limited by the embodiments below. Further, in description of the drawings, the same components are denoted by the same reference symbols. Furthermore, in each of the drawings referred to in the description below, shapes, sizes, and positional relationships are only schematically illustrated so that the content may be understood. Namely, the present disclosure is not limited to only the shapes, the sizes, and the positional relationships illustrated in the drawings. Moreover, in the description below, a digital still camera will be described as one example of an imaging apparatus, but a mobile phone, a terminal device, and an action cam with imaging functions may be applicable.

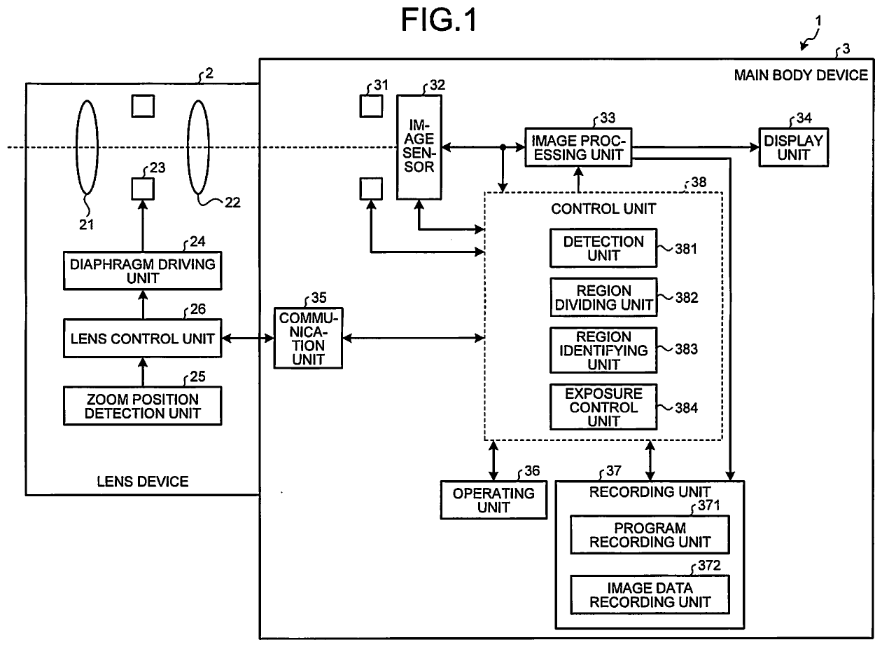

FIG. 1 is a block diagram illustrating a functional configuration of an imaging apparatus according to an embodiment. An imaging apparatus 1 illustrated in FIG. 1 includes a lens device 2 that forms an object image, and a main body device 3 that is detachably attached to the lens device 2. Meanwhile, in the following description, the lens device 2 and the main body device 3 are configured as separate bodies, but the lens device 2 and the main body device 3 may be integrated with each other.

A configuration of the lens device 2 will be described below.

The lens device 2 includes a front group lens 21, a rear group lens 22, a diaphragm 23, a diaphragm driving unit 24, a zoom position detection unit 25, and a lens control unit 26.

The front group lens 21 collects light from a predetermined field of view in order to form an optical image (object image) on a light receiving surface of an image sensor 32 of the main body device 3 (to be described later). The front group lens 21 is configured with one or more lenses. Further, the front group lens 21 changes an angle of view by moving along an optical axis L1.

The rear group lens 22 moves along the optical axis L1 to adjust a focus position of the object image. The rear group lens 22 is configured with one or more lenses.

The diaphragm 23 adjusts exposure by controlling incident amount of light collected by the front group lens 21 under the control of the diaphragm driving unit 24.

The diaphragm driving unit 24 drives the diaphragm 23 and controls a diaphragm value of the diaphragm 23 under the control of the lens control unit 26. The diaphragm driving unit 24 is configured with a stepping motor, a direct current (DC) motor, or the like.

The zoom position detection unit 25 detects a position of the front group lens 21 on the optical axis L1 to detect zoom information on a current angle of view of the lens device 2, and outputs the zoom information to the lens control unit 26. The zoom position detection unit 25 is configured with, for example, a photo interrupter, an encoder, or the like.

The lens control unit 26 controls the diaphragm 23 by controlling the diaphragm driving unit 24 based on a control signal that is input from the main body device 3. The lens control unit 26 is configured with, for example, a memory and a processor including hardware, such as a central processing unit (CPU).

A configuration of the main body device 3 will be described below.

The main body device 3 includes a shutter 31, the image sensor 32, an image processing unit 33, a display unit 34, a communication unit 35, an operating unit 36, a recording unit 37, and a control unit 38.

The shutter 31 performs open-close operation and switches a state of the image sensor 32 between an exposure state and a light shielding state under the control of the control unit 38. Further, the shutter 31 adjusts a shutter speed that is an incident time of light that enters the image sensor 32 under the control of the control unit 38. The shutter 31 is configured with a mechanical shutter, such as a focal plane shutter.

The image sensor 32 is configured with an imaging image sensor, such as a complementary metal oxide semiconductor (CMOS), in which a plurality of pixels each receiving light of the object image collected by the lens device 2 and performing photoelectric conversion to form image data are arranged in a two-dimensional matrix manner. The image sensor 32 generates image data at a predetermined frame rate and outputs the image data to the image processing unit 33 under the control of the control unit 38. Further, the image sensor 32 sequentially perform reading for each of pixel lines in an image reading direction by using an electronic shutter, such as a rolling shutter, and outputs the read data to the image processing unit 33 under the control of the control unit 38. Furthermore, the image sensor 32 may implement global shutter under the control of the control unit 38. Meanwhile, the image sensor 32 is configured by arranging a Bayer color filter (RGB color filter) on the light receiving surface. It is of course possible to arrange a filter for detecting a phase difference on the Bayer color filter on the image sensor 32, apart from the Bayer arrangement. Moreover, the image sensor 32 may include a complementary color filter in which, for example, magenta, yellow, and cyan are arranged, apart from the Bayer arrangement.

The communication unit 35 transmits a control signal that is input from the control unit 38 to the lens control unit 26 of the lens device 2 and outputs various signals, such as signals including the angle of view of the lens device 2, that is input from the lens control unit 26 to the control unit 38. Meanwhile, the communication unit 35 bidirectionally transmits and receives the control signal and the various signals in a wired or wireless manner in accordance with a predetermined communication standard. The communication unit 35 is configured with a communication module or the like.

The image processing unit 33 performs predetermined image processing on the image data input from the image sensor 32, and outputs the processed image data to the display unit 34. The image processing unit 33 performs a development process, such as a gain-up process, a white balance adjustment process, or a demosaicing process, on the image data, and outputs the processed image data to the display unit 34, the recording unit 37, and the control unit 38. The image processing unit 33 is configured with, for example, a memory and a processor including hardware, such as a graphics processing unit (GPU) and a field programmable gate array (FPGA).

The display unit 34 displays an image or a live view image corresponding to the image data input from the image processing unit 33. The display unit 34 is configured with a display panel made of organic electro luminescence (EL), liquid crystal, or the like.

The operating unit 36 receives input of various kinds of operation on the imaging apparatus 1. Specifically, the operating unit 36 receives input of an instruction signal for instructing the imaging apparatus 1 to capture an image or an instruction signal for changing an imaging driving mode of the imaging apparatus 1, and outputs the received instruction signal to the control unit 38. The operating unit 36 is configured with a touch panel, a switch, a button, a joystick, a dial, and the like.

The recording unit 37 records various kinds of information on the imaging apparatus 1. The recording unit 37 includes a program recording unit 371 for recording various programs to be executed by the imaging apparatus 1, and an image data recording unit 372 for recording image data. The recording unit 37 is configured with a volatile memory, a nonvolatile memory, a recording medium, and the like. Meanwhile, the recording unit 37 may be detachably attachable to the main body device 3.

The control unit 38 comprehensively controls each of the units included in the imaging apparatus 1. The control unit 38 is configured with a memory and a processor including hardware, such as a CPU, an FPGA, or an application specific integrated circuit (ASIC). The control unit 38 includes a detection unit 381, a region dividing unit 382, a region identifying unit 383, and an exposure control unit 384.

The detection unit 381 detects a flicker cycle of a light source from an incident light that enters the image sensor 32 used for multi-zone metering. Specifically, the detection unit 381 detects the flicker cycle of the light source based on the image data generated by the image sensor 32.

The region dividing unit 382 generates a difference image between an image in which a light intensity fringe is not present and an image in which a light intensity fringe is present based on the flicker cycle detected by the detection unit 381, and divides the difference image into a plurality of regions along an image reading direction of the image sensor 32.

The region identifying unit 383 identifies, from among the plurality of regions divided by the region dividing unit 382, a first color unevenness occurrence region including a portion in which a light intensity waveform decreases, a second color unevenness occurrence region including a portion in which the light intensity waveform decreases, and a color unevenness non-occurrence region in which the light intensity waveform increases from the first color unevenness occurrence region to the second color unevenness occurrence region. Specifically, the region identifying unit 383 identifies the first color unevenness occurrence region and the second color unevenness occurrence region based on a maximum value and a minimum value of luminance values in each of the regions.

The exposure control unit 384 determines a center position of an exposure period in the color unevenness non-occurrence region identified by the region identifying unit 383, and controls exposure. Specifically, the exposure control unit 384 controls exposure such that, in a direction perpendicular to the image reading direction of the image sensor 32, the center position of the exposure period located in the color unevenness non-occurrence region meets conditions 1 to 3 below.

Condition 1: located at a position at which the exposure period does not include the first color unevenness occurrence region and the second color unevenness occurrence region at the time of exposure;

Condition 2: located at a position at which the exposure period does not include a minimum light intensity position at the side of the first color unevenness occurrence region in the color unevenness non-occurrence region; and

Condition 3: located at a position at which the exposure period does not include a peak intensity position at the side of the second color unevenness occurrence region in the color unevenness non-occurrence region.

Further, the center position of the exposure period is located in the middle (½) of a distance between the first color unevenness occurrence region and the second color unevenness occurrence region, from the first color unevenness occurrence region toward the second color unevenness occurrence region.

A timing of color unevenness caused by flicker will be described below.

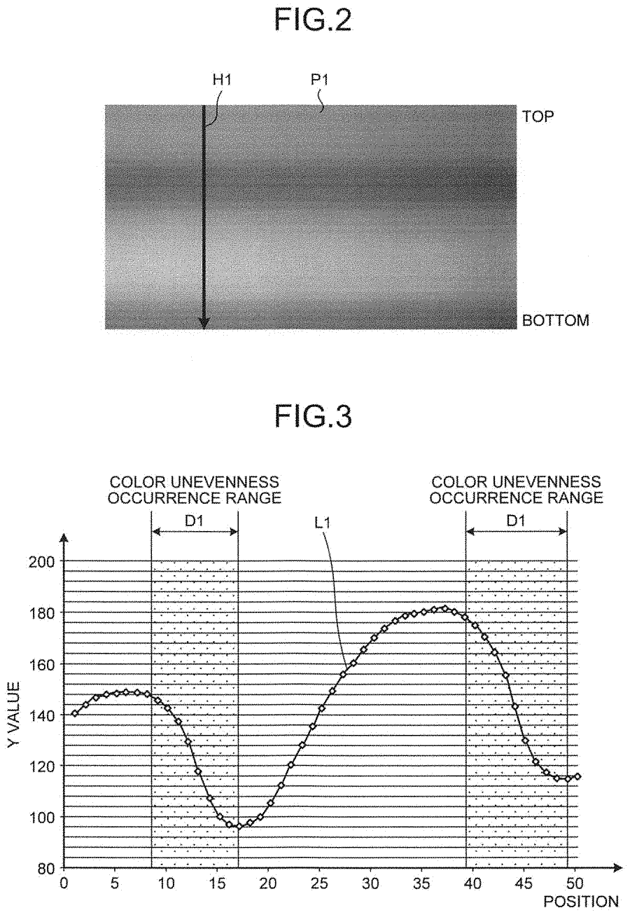

FIG. 2 is a diagram schematically illustrating an image that is obtained when flicker occurs. FIG. 3 is a diagram schematically illustrating a luminance value at each of positions divided for each of regions in a vertical direction in the image in FIG. 2. In FIG. 3, a curve L1 schematically represents a change of the luminance value (Y value) at each of the positions divided for each of the regions in the vertical direction in the image. Further, in FIG. 3, a horizontal axis represents the position of each of the regions in the vertical direction in the image, and a vertical axis represents an output value of the luminance value. More specifically, in FIG. 3, the horizontal axis represents the position of each of the regions from an upper side to a lower side in the vertical direction indicated by a straight line Hi in FIG. 2, and a smaller number indicates an upper position. Meanwhile, an image P1 in FIG. 2 is an image in which a light intensity change that occurs in the flicker light source over more than a cycle is captured by using an electronic shutter that has a longer time of curtain speed than the flicker cycle of the light source. Furthermore, the flicker light source is a fluorescent light. Moreover, FIG. 2 illustrates a graph in an image that is captured with a plain background; however, in actual imaging scenes, there may be an imaging scene without a plain background. Therefore, in the difference image, a flicker component clearly appears as a graph.

As represented by the image P1 in FIG. 2 and the curve L1 in FIG. 3, the color unevenness occurs in a period D1 in which the light intensity falls down.

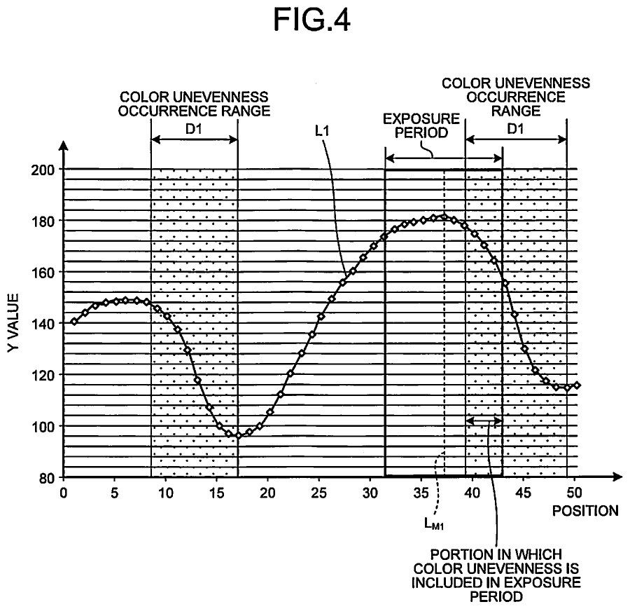

FIG. 4 is a diagram for schematically explaining one example of a case in which imaging is performed such that a center of an exposure period coincides with a timing of a peak of a flicker waveform according to the known technique. In FIG. 4, a curve L1 schematically represents a change of a luminance value (Y value) at each of positions divided for each of regions in a vertical direction in an image. Furthermore, in FIG. 4, a horizontal axis represents the position of each of the regions in the vertical direction in the image, and a vertical axis represents an output value of the luminance value.

In the known technique, if the timing of the center of the exposure period coincides with the peak L_{M1} (maximum value) of the flicker waveform, as represented by a relationship between the curve L1 and the exposure period in FIG. 4, a latter half of the exposure period is included in a color unevenness occurrence range D1. Therefore, in the known technique, with respect to deviation of a predicted peak timing of the flicker waveform that occurs due to slow curtain speed, length of the exposure period, or an error in a power supply frequency, an allowable width (allowable time) in which an influence of the color unevenness may be avoided is reduced. Thus there was a problem that appearance of a captured image is degraded by the color unevenness.

A process performed by the imaging apparatus 1 will be described below.

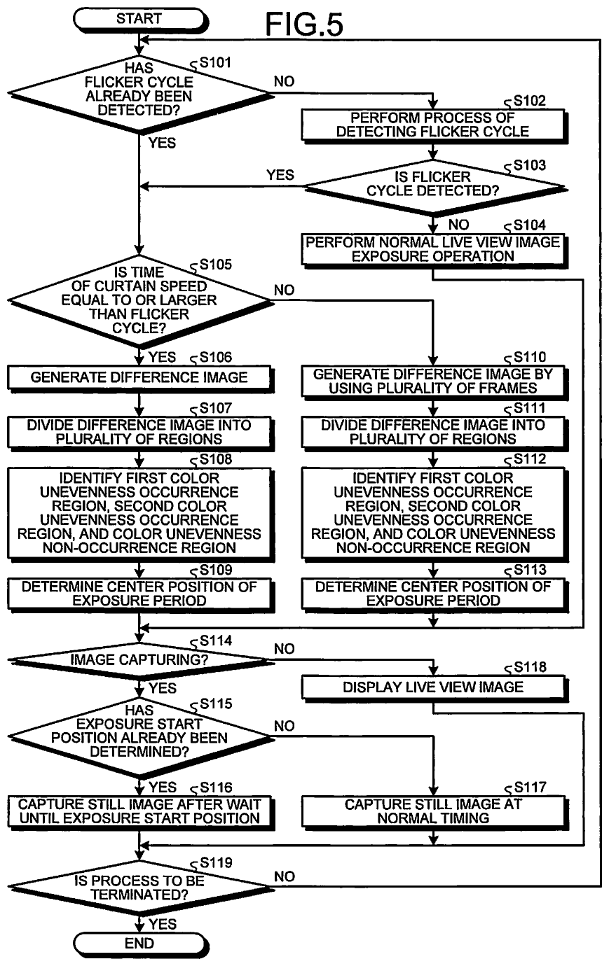

FIG. 5 is a flowchart illustrating an outline of the process performed by the imaging apparatus 1.

As illustrated in FIG. 5, if the detection unit 381 has already detected the flicker cycle of the light source (Step S101: Yes), the imaging apparatus 1 goes to Step S105 to be described later. In contrast, if the detection unit 381 has not already detected the flicker cycle of the light source (Step S101: No), the imaging apparatus 1 goes to Step S102 to be described below

At Step S102, the detection unit 381 detects the flicker cycle of the light source. Specifically, the detection unit 381 detects the flicker cycle of the light source by using a well-known technique. For example, the detection unit 381 detects the flicker cycle of the light source (for example, 50 Hz or 60 Hz) based on a plurality of live view images corresponding to the image data generated by the image sensor 32, and based on a distance or a position at which the flicker has occurred in a direction perpendicular to the image reading direction (horizontal line) of the image sensor 32 with reference to temporally consecutive two live view images.

Subsequently, if the detection unit 381 detects the flicker cycle (Step S103: Yes), the imaging apparatus 1 goes to Step S105 to be described later. In contrast, if the detection unit 381 does not detect the flicker cycle (Step S103: No), the imaging apparatus 1 goes to Step S104 to be described below.

At Step S104, the exposure control unit 384 performs normal live view image exposure operation for causing the image sensor 32 to generate a normal live view image. Specifically, the exposure control unit 384 controls exposure driving of the image sensor 32 such that appropriate exposure is implemented, based on luminance values that are obtained by metering using the image data of the image sensor 32. After Step S104, the imaging apparatus 1 goes to Step S114 to be described later.

At Step S105, the control unit 38 determines whether a time of the curtain speed of the shutter 31 is equal to or larger than the flicker cycle. If the control unit 38 determines that the time of the curtain speed of the shutter 31 is equal to or larger than the flicker cycle (Step S105: Yes), the region dividing unit 382 generates a difference image between an image in which a light intensity fringe is not present and an image in which a light intensity fringe is present (Step S106), and divides the difference image into a plurality of regions along the image reading direction of the image sensor 32 (Step S107). Specifically, first, the region dividing unit 382 controls an exposure period Tv and ISO sensitivity Sv of the image sensor 32 and causes the image sensor 32 to perform live view image exposure operation for detecting an avoidance timing for avoiding color unevenness caused by the flicker of the light source. More specifically, the region dividing unit 382 causes the image sensor 32 to generate a first live view image that is a live view image in which a flicker fringe is not present (the image in which a light intensity fringe is not present) and a second live view image in which a flicker fringe is present (the image in which a light intensity fringe is present), based on the flicker cycle detected by the detection unit 381. Then, the region dividing unit 382 generates a difference image in which the flicker fringe is extracted, based on the first live view image and the second live view image.

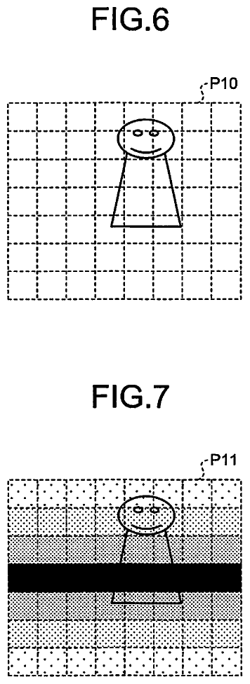

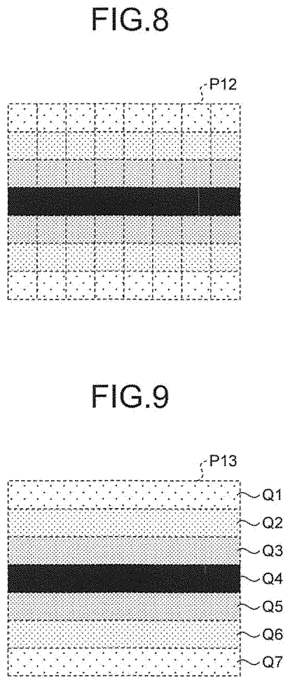

FIG. 6 is a diagram schematically illustrating the first live view image in which a flicker fringe is not present. FIG. 7 is a diagram schematically illustrating the second live view image in which flicker fringes are present. FIG. 8 is a diagram illustrating an image in which the flicker fringes are extracted. FIG. 9 is a diagram schematically illustrating object luminance values By that are obtained by averaging object luminance values in each of metering regions for each of image reading directions.

As illustrated in FIG. 6 to FIG. 9, the region dividing unit 382 generates a third image P12 in which the flicker fringes are extracted, based on a first live view image P10 and a second live view image P11. Then, as illustrated in FIG. 9, the region dividing unit 382 divides the third image P12 into a plurality of regions at predetermined intervals along the image reading direction (horizontal direction) of the image sensor 32. Further, the region dividing unit 382 generates a third image P13 in which the object luminance values By in metering regions of the third image P12 are averaged for each of the regions Q1 to Q7 that are divided along the image reading direction. Meanwhile, in FIG. 6 to FIG. 9, the region dividing unit 382 extracts the flicker fringes based on the object luminance values in the metering regions in each of the image reading directions of the third image P13, but may extract the flicker fringes based on color information on the regions in each of the image reading directions of the third image P13.

Referring back to FIG. 5, explanation on the process from Step S108 will be continued.

At Step S108, the region identifying unit 383 identifies a first color unevenness occurrence region, a second color unevenness occurrence region, and a color unevenness non-occurrence region from among the plurality of regions Q1 to Q7 that are divided by the region dividing unit 382. Here, the first color unevenness occurrence region is a region including a portion in which a light intensity waveform decreases. The second color unevenness occurrence region is a region including a portion in which the light intensity waveform decreases. The color unevenness non-occurrence region is a region in which the light intensity waveform increases from the first color unevenness occurrence region to the second color unevenness occurrence region. For example, the region identifying unit 383 identifies the first color unevenness occurrence region and the second color unevenness occurrence region based on a maximum value and a minimum value of the luminance values in each the regions Q1 to Q7.

Subsequently, the exposure control unit 384 determines the center position of the exposure period in the color unevenness non-occurrence region identified by the region identifying unit 383, and controls exposure of the imaging apparatus 1 (Step S109).

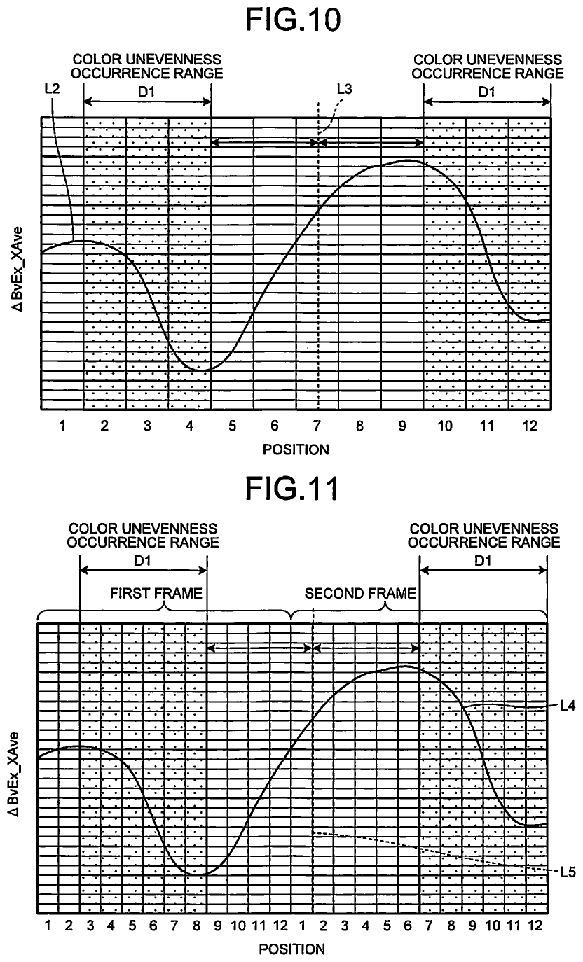

FIG. 10 is a diagram for schematically explaining the center position of the exposure period that is determined by the exposure control unit 384. In FIG. 10, the curve L2 schematically represents a change of a luminance value (Y value) at each of positions divided for each of predetermined regions in the image reading direction in the image. Further, in FIG. 10, a horizontal axis represents the position of each of the regions in the image reading direction in the image, and a vertical axis represents an output value of the luminance value.

As represented by the curve L2 in FIG. 10, the exposure control unit 384 determines that a timing at a position L3 in the middle of a period from a bottom position (minimum value) to a peak position (maximum value) in the color unevenness non-occurrence region that is identified by the region identifying unit 383 is adopted as the center of the exposure period in still-image capturing. Specifically, the exposure control unit 384 determines the center of the exposure period in the still-image capturing such that, in the direction perpendicular to the image reading direction of the image sensor 32, the center position of the exposure period located in the color unevenness non-occurrence region meets conditions 1 to 3 below.

Condition 1: located at a position at which the exposure period does not include the first color unevenness occurrence region and the second color unevenness occurrence region at the time of exposure;

Condition 2: located at a position at which the exposure period does not include a minimum light intensity position at the side of the first color unevenness occurrence region in the color unevenness non-occurrence region; and

Condition 3: located at a position at which the exposure period does not include a peak intensity position at the side of the second color unevenness occurrence region in the color unevenness non-occurrence region.

In the case illustrated in FIG. 10, the exposure control unit 384 determines a position of a straight line L3 as the center of the exposure period in the still-image capturing. In this case, the exposure control unit 384 calculates the exposure period in the still-image capturing by using a read time per region. Specifically, the exposure control unit 384 calculates the exposure period by using Expressions (1) to (3) below.

Read time per region=read time for a single line in the image reading direction of the image sensor 32×the number of pixels in the vertical direction in a single region (1)

Rising time of flicker light=the number of regions from the bottom position to the peak position in the unevenness non-occurrence region×read time per region (2)

Center time of the exposure period in the still-image capturing=rising time of flicker light×(½) (3)

In this manner, the exposure control unit 384 calculates the center time of the exposure period in the still-image capturing in the direction perpendicular to the image reading direction of the image sensor 32, and determines the calculated time as the center of the exposure period in the still-image capturing.

At Step S105, if the control unit 38 determines that the time of the curtain speed of the shutter 31 is not equal to or larger than the flicker cycle (Step S105: No), the region dividing unit 382 generates a difference image between the image in which the light intensity fringe is not present and the image in which the light intensity fringe is present, by using pieces of image data of a plurality of frames that are consecutively generated by the image sensor 32 while adopting the frames such that a total time of the pieces of image data of the plurality of frames becomes equal to or larger than the flicker cycle (Step S110), and divides the difference image into a plurality of regions along the image reading direction of the image sensor 32 (Step S111). Meanwhile, a dividing method used by the region dividing unit 382 is the same as the method used when the time of the curtain speed of the shutter 31 is equal to or larger than the flicker cycle, and therefore, detailed explanation thereof will be omitted.

Subsequently, the region identifying unit 383 identifies the first color unevenness occurrence region, the second color unevenness occurrence region, and the color unevenness non-occurrence region from the plurality of regions Q1 to Q7 that are divided by the region dividing unit 382 (Step S112).

Thereafter, the exposure control unit 384 determines the center position of the exposure period in the color unevenness non-occurrence region identified by the region identifying unit 383, and controls exposure of the imaging apparatus 1 (Step S113).

FIG. 11 is a diagram for schematically explaining the center position of the exposure period that is determined by the exposure control unit 384. In FIG. 11, a curve L4 schematically represents a change of a luminance value (Y value) at each of positions divided for each of predetermined regions in the image reading direction in the image. Further, in FIG. 11, a horizontal axis represents the position of each of the regions in the image reading direction in the image, and a vertical axis represents an output value of the luminance value.

As represented by the curve L4 in FIG. 11, similarly to the case in which the time of the curtain speed of the shutter 31 is equal to or larger than the flicker cycle, the exposure control unit 384 determines that a timing at a position in the middle of a period from a bottom position (minimum value) to a peak position (maximum value) in color unevenness non-occurrence regions that are identified by the region identifying unit 383 in a plurality of frames is adopted as the center of the exposure period in the still-image capturing. In the case illustrated in FIG. 11, the exposure control unit 384 determines a position of a straight line L5 as the center of the exposure time in the still-image capturing. In this case, similarly to the case in which the time of the curtain speed of the shutter 31 is equal to or larger than the flicker cycle, the exposure control unit 384 calculates the exposure period in the still-image capturing and determines the calculated time as the center of the exposure period in the still-image capturing. Meanwhile, the exposure control unit 384 may determine the center position of the exposure period and control the exposure by using a different method. For example, the exposure control unit 384 determines that the rising time of the flicker light=a theoretical flicker cycle ( 1/100 (sec) or 1/120 (sec))×(½), calculates the exposure period in the still-image capturing through the same process as in the case in which the time of the curtain speed of the shutter 31 is equal to or larger than the flicker cycle, and adopts the calculated time as the center of the exposure period in the still-image capturing. This method may be used when a continuous waveform is not observed even if consecutive frames are observed (a display frame rate is lower than a highest frame rate of the curtain speed of the shutter 31, for example).

After Step S109 or Step S113, if an instruction signal for instructing image capturing is input from the operating unit 36 (Step S114: Yes), the imaging apparatus 1 goes to Step S115 to be described later. In contrast, if the instruction signal for instructing image capturing is not input from the operating unit 36 (Step S114: No), the imaging apparatus 1 goes to Step S118 to be described later.

At Step S115, if the exposure control unit 384 has already determined an exposure start position (Step S115: Yes), the imaging apparatus 1 goes to Step S116 to be described later. In contrast, if the exposure control unit 384 has not already determined the exposure start position (Step S115: No), the imaging apparatus 1 goes to Step S117 to be described later.

At Step S116, the exposure control unit 384 postpones the exposure start timing of the image sensor 32 until the exposure start position and causes the image sensor 32 to capture a still image after a wait until the exposure start position. After Step S116, the imaging apparatus 1 goes to Step S119 to be described later.

At Step S117, the exposure control unit 384 causes the image sensor 32 to capture a still image at a normal timing. After Step S117, the imaging apparatus 1 goes to Step S119 to be described later.

At Step S118, the exposure control unit 384 causes the image sensor 32 to display the live view image on a display unit 41. After Step S118, the imaging apparatus 1 goes to Step S119 to be described below.

At Step S119, if an instruction signal for terminating image capturing is input from the operating unit 36 (Step S119: Yes), the imaging apparatus 1 terminates the process. In contrast, if the instruction signal for terminating image capturing is not input from the operating unit 36 (Step S119: No), the imaging apparatus 1 returns to Step S101 as described above.

According to the embodiment as described above, the exposure period is determined so as to overlap with the position that does not overlap with the color unevenness occurrence region in which flicker occurs (position that does not overlap with a downward slope of the waveform), so that it is possible to reliably avoid the flicker.

Furthermore, according to the embodiment, the position that overlaps with an upward slope of the waveform up to the light intensity peak is a position at which a color change is less likely to occur even if a light intensity change occurs prior to or posterior to the position, so that the position is less likely to be affected by flicker.

An example will be described below. The same components as those of the imaging apparatus 1 according to the embodiment as described above are denoted by the same reference symbols, and detailed explanation thereof will be omitted.

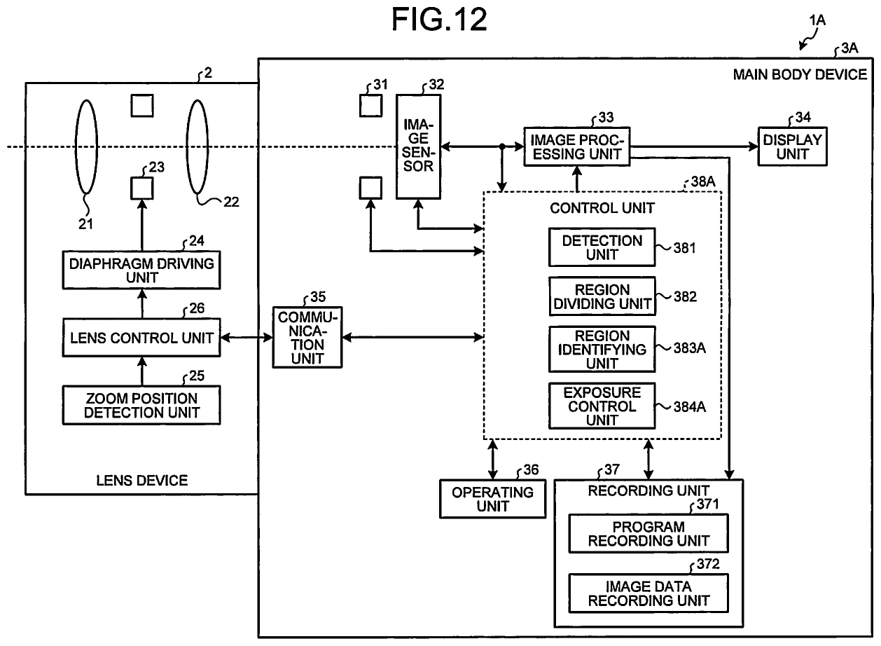

FIG. 12 is a block diagram illustrating an imaging apparatus according to the example. An imaging apparatus 1A illustrated in FIG. 12 includes the lens device 2 that forms an object image, and a main body device 3A that is detachably attached to the lens device 2. Meanwhile, in the following description, the lens device 2 and the main body device 3A are configured as separate bodies, but the lens device 2 and the main body device 3A may be integrated with each other.

A configuration of the main body device 3A will be described below.

The main body device 3A includes the shutter 31, the image sensor 32, the image processing unit 33, the display unit 34, the communication unit 35, the operating unit 36, the recording unit 37, and a control unit 38A.

The control unit 38A comprehensively controls each of the units included in the imaging apparatus 1A. The control unit 38A is configured with a memory and a processor including hardware, such as a CPU, an FPGA, or an ASIC. The control unit 38A includes the detection unit 381, the region dividing unit 382, a region identifying unit 383A, and an exposure control unit 384A.

The region identifying unit 383A identifies, from among the plurality of regions divided by the region dividing unit 382, the first color unevenness occurrence region, the second color unevenness occurrence region, and the color unevenness non-occurrence region that is located between the first color unevenness occurrence region and the second color unevenness occurrence region. Specifically, the region identifying unit 383A identifies the first color unevenness occurrence region and the second color unevenness occurrence region based on color information on each of the regions.

The exposure control unit 384A identifies, in the regions identified by the region identifying unit 383A, a color that has a largest difference between a maximum value and a minimum value with respect to changes in output values of three primary colors (R, G, B) of light, determines, as the center position of the exposure period, a center position of a distance between a first positon corresponding to a minimum output value of the identified color in the first color unevenness occurrence region and a second position corresponding to a minimum output value of the identified color in the second color unevenness occurrence region, and controls exposure.

A timing of color unevenness caused by flicker will be described below.

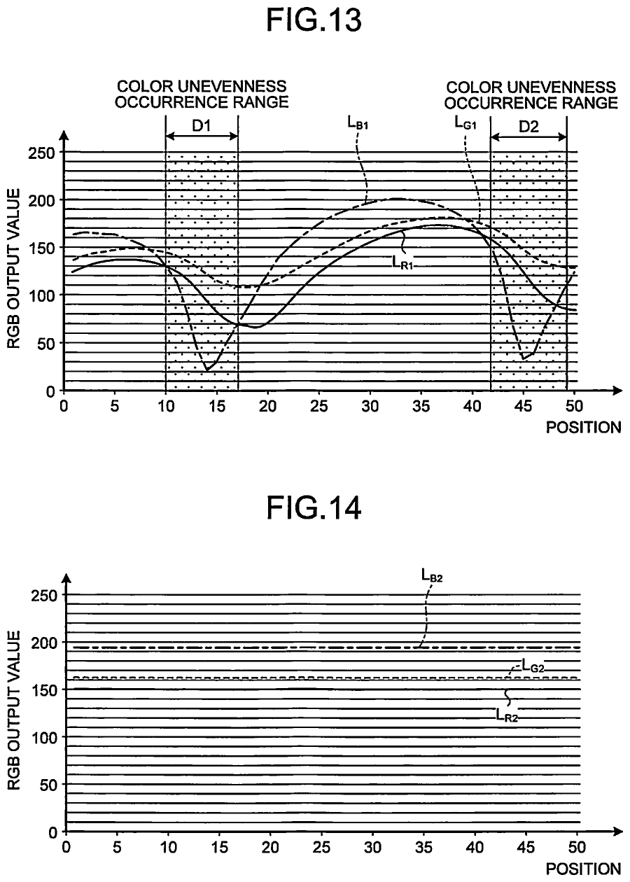

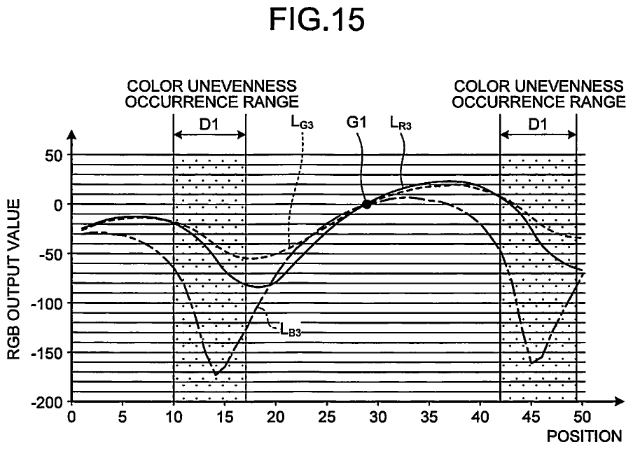

FIG. 13 is a diagram schematically illustrating RGB output values at each of positions divided for each of regions in a vertical direction in the image in FIG. 2. FIG. 14 is a diagram schematically illustrating RGB output values at each of positions divided for each of regions in a vertical direction in an image in which a flicker is not present. FIG. 15 is a diagram schematically illustrating RGB output values at each of positions divided for each of regions in a vertical direction in a difference image obtained by subtracting the image in FIG. 14 from the image in FIG. 13. Further, in FIG. 13 to FIG. 15, horizontal axes represent the position of each of the regions in the vertical direction in the image, and vertical axes represent an output value of the luminance value. More specifically, in FIG. 13 to FIG. 15, the horizontal axes represent the position of each of the regions from an upper side to a lower side in the vertical direction indicated by the straight line Hi in FIG. 2, and a smaller number indicates an upper position. Moreover, in FIG. 13 to FIG. 15, curves L_{R1} to L_{R3} represent output values of R (red), curves L_{G1} to L_{G3} represent output values of G (green), and curves L_{B1} to L_{B3} represent output values of B (blue). Meanwhile, FIGS. 13 to 15 illustrate graphs in images that are captured with plain backgrounds; however, in actual imaging scenes, there may be an imaging scene without a plain background. Therefore, in the difference image, a flicker component clearly appears as a graph.

As represented by the curve L_{R3}, the curve L_{G3}, and the curve L_{B3} in FIG. 15, ranges D1 in which color unevenness occurs due to flicker are ranges that include positions (regions) at which a difference among the RGB output values in the difference image is the largest.

In contrast, as represented by the curve L_{R3}, the curve L_{G3}, and the curve L_{B3} in FIG. 15, a range in which color unevenness due to flicker does not occur is a position (region) at which the difference among the RGB values in the difference image is the smallest. Therefore, the exposure control unit 384A calculates the exposure timing based on the timing in which the position at which the difference among the RGB output values (brightness or luminance of each of RGB) in the difference image has a minimum value serves as a center position. Specifically, the exposure control unit 384A acquires, as an avoidance timing for avoiding color unevenness due to the light source, a timing in which a position G1 at which the difference among the RGB output values (brightness or luminance of each of RGB) in the difference image has the minimum value serves as the center position, and calculates the exposure timing based on the avoidance timing. For example, the exposure control unit 384A calculates and determines the exposure timing such that the avoidance timing that is a timing in which the position G1 at which the difference among the RGB output values in the difference image has the minimum value serves as the center position is adopted as an intermediate time of the exposure period that is determined based on the ISO sensitivity of the image sensor 32, a diaphragm value of the diaphragm 23, and a shutter speed of the shutter 31. Further, if light intensity of a region with the minimum value of the light intensity (the RGB output values) in the difference image is set to 0% and light intensity of a region with the maximum value of the light intensity (the RGB output values) in the difference image is set to 100%, the exposure control unit 384A acquires the avoidance timing such that light intensity (RGB output value) in the difference image falls in a range from 20% to 80%. Furthermore, the exposure control unit 384A acquires the avoidance timing such that the avoidance timing is located in the middle from the region with minimum value to the region with the maximum value of the light intensity (the RGB output values) in the difference image. More specifically, the exposure control unit 384A acquires the avoidance timing such that the avoidance timing is located in the middle from the region with the minimum value to the region with the maximum value of the light intensity (the RGB output values) in the difference image.

Meanwhile, while the exposure control unit 384A acquires, as the avoidance timing, the timing in which the position at which the difference among the RGB output values (brightness or luminance of each of RGB) in the difference image has the minimum value serves as the center position, the exposure control unit 384A may acquire, as the avoidance timing, a timing in which the difference among the RGB output values in the difference image does not include the maximum value serves as the center position. Furthermore, the exposure control unit 384A may acquire, as the avoidance timing, a timing including a center position of a range in which color unevenness due to flicker does not occur, based on a shape of a difference component of any of the RGB components that is most likely to be affected by the color unevenness due to flicker. Moreover, the exposure control unit 384A may acquire the avoidance timing such that the shape of the difference component of any of the RGB components that is most likely to be affected by the color unevenness due to flicker is located in the middle from the region with the minimum value to the region with maximum value.

A process performed by the imaging apparatus 1A will be described below.

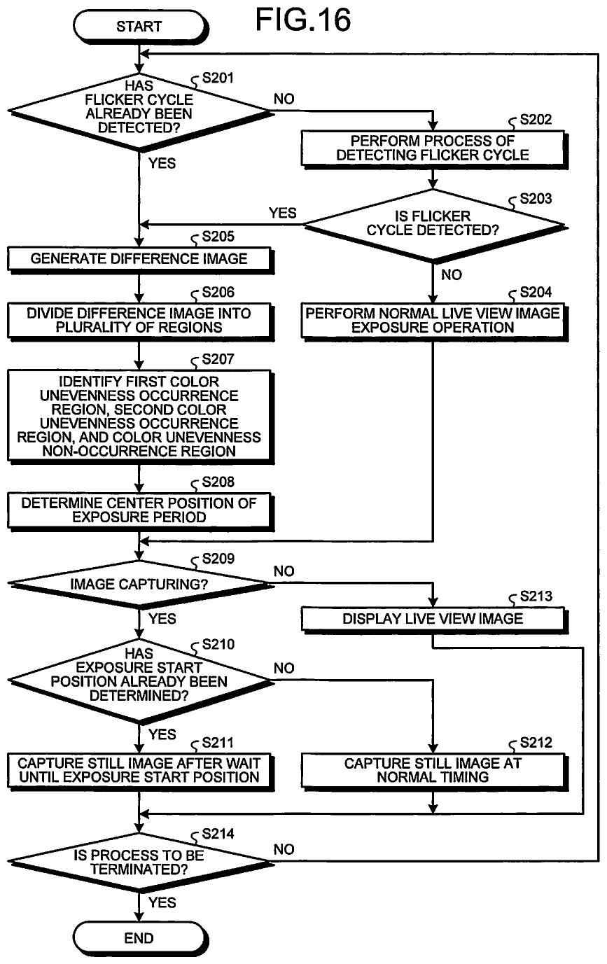

FIG. 16 is a flowchart illustrating an outline of the process performed by the imaging apparatus 1A.

As illustrated in FIG. 16, if the detection unit 381 has already detected the flicker cycle of the light source (Step S201: Yes), the imaging apparatus 1A goes to Step S205 to be described later. In contrast, if the detection unit 381 has not detected the flicker cycle of the light source (Step S201: No), the imaging apparatus 1A goes to Step S202 to be described below.

At Step S202, the detection unit 381 detects the flicker cycle of the light source. Specifically, the detection unit 381 detects the flicker cycle of the light source by using a well-known technique. For example, the detection unit 381 detects the flicker cycle of the light source (for example, 50 Hz or 60 Hz) based on a plurality of live view images corresponding to the image data generated by the image sensor 32, and based on a distance or a position at which the flicker has occurred in a direction perpendicular to the image reading direction (horizontal line) of the image sensor 32 with reference to temporally consecutive two live view images.

Subsequently, if the detection unit 381 detects the flicker cycle (Step S203: Yes), the imaging apparatus 1A goes to Step S205 to be described later. In contrast, if the detection unit 381 does not detect the flicker cycle (Step S203: No), the imaging apparatus 1A goes to Step S204 to be described below.

At Step S204, the exposure control unit 384A performs the normal live view image exposure operation for causing the image sensor 32 to generate a normal live view image. Specifically, the exposure control unit 384A controls the exposure driving of the image sensor 32 such that appropriate exposure is implemented, based on luminance values that are obtained by metering using the image data of the image sensor 32. After Step S204, the imaging apparatus 1A goes to Step S209 to be described later.

At Step S205, the region dividing unit 382 generates a difference image between the image in which the light intensity fringe is not present and the image in which the light intensity fringe is present.

Subsequently, the region dividing unit 382 divides the difference image into a plurality of regions along the image reading direction of the image sensor 32 (Step S206). Specifically, the region dividing unit 382 divides the difference image into a plurality of regions along the image reading direction of the image sensor 32 through the same process as in the embodiment as described above.

Thereafter, the region identifying unit 383A identifies the first color unevenness occurrence region, the second color unevenness occurrence region, and the color unevenness non-occurrence region located between the first color unevenness occurrence region and the second color unevenness occurrence region from among the plurality of regions that are divided by the region dividing unit 382 (Step S207). Specifically, the region identifying unit 383A identifies the first color unevenness occurrence region and the second color unevenness occurrence region based on the color information on each of the regions.

Subsequently, the exposure control unit 384A identifies, in the regions identified by the region identifying unit 383A, a color that has a largest difference between a maximum value and a minimum value with respect to changes in the output values of the three primary colors (R, G, B) of light, determines, as the center position of the exposure period, the center position of the distance between the first positon corresponding to the minimum output value of the identified color in the first color unevenness occurrence region and the second position corresponding to the minimum output value of the identified color in the second color unevenness occurrence region, and controls exposure (Step S208).

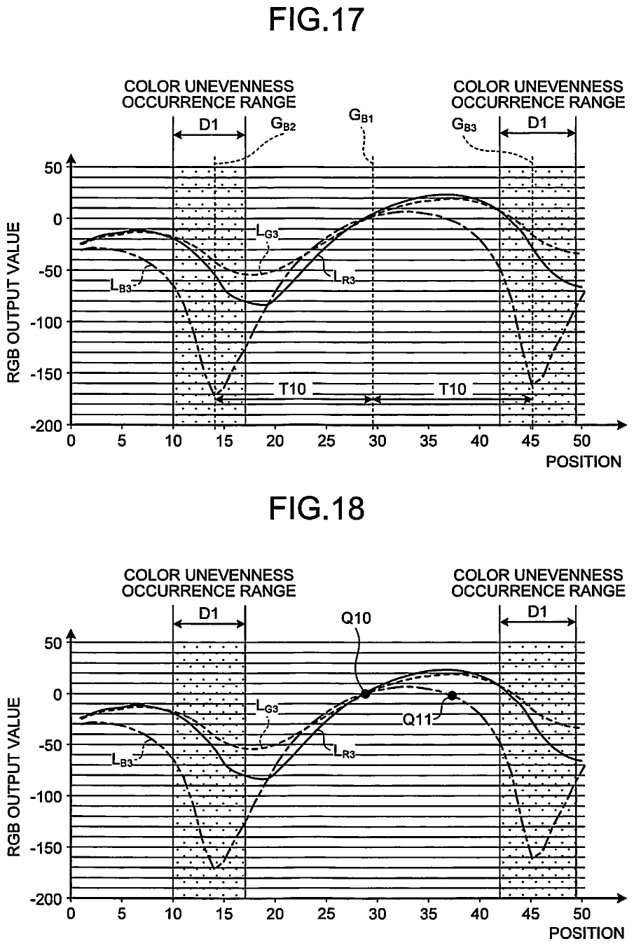

FIG. 17 is a diagram for schematically explaining the center position of the exposure period that is determined by the exposure control unit 384A. In FIG. 17, a horizontal axis represents a position of each of regions in a vertical direction of the difference image, and a vertical axis represents an output value. Further, in FIG. 17, the curve L_{R3} represents the output value of R (red), the curve L_{G3} represents the output value of G (green), and the curve L_{B3} represents the output value of B (blue). More specifically, in FIG. 17, the horizontal axis represents the position of each of the regions from an upper side to a lower side in the vertical direction of the difference image, and a smaller number indicates an upper position.

As illustrated in FIG. 17, first, the exposure control unit 384A selects, as information on a determination criterion, a color for which a difference between a maximum value and a minimum value is the largest among pieces of difference RGB information each being an average in the horizontal direction, for the region in a vertical direction of a multi-zone metering that is identified by the region identifying unit 383A. In the case illustrated in FIG. 17, the exposure control unit 384A selects the B information as the determination criterion. The reason for selecting the largest difference from among the three colors corresponding to the R information, the G information, and the B information is to select color information that most affects color unevenness that varies due to color characteristics of the light source.

Subsequently, the exposure control unit 384A determines two minimum values of color information based on the selected color information, determines a timing corresponding to a center G_{B1} of an interval between two minimum values G_{B2} and G_{B3} as the center position of the exposure period, as the avoidance timing for avoiding color unevenness due to flicker, and controls exposure. More specifically, the exposure control unit 384A acquires a central timing of an exposure period (T10+T10) by adopting the center G_{B1} of the interval between the two minimum values G_{B2} and G_{B3} as the avoidance timing. In other words, the exposure control unit 384A determines the avoidance timing from the minimum value of a color information waveform in the third image that is a flicker fringe extraction result, determines the avoidance timing as the center position of the exposure period, and controls exposure.

Referring back to FIG. 16, explanation on Step S209 and subsequent steps will be continued.

If an instruction signal for instructing image capturing is input from the operating unit 36 (Step S209: Yes), the imaging apparatus 1A goes to Step S210 to be described later. In contrast, if the instruction signal for instructing image capturing is not input from the operating unit 36 (Step S209: No), the imaging apparatus 1A goes to Step S213 to be described later.

At Step S210, if the exposure start timing has already been calculated (Step S210: Yes), the imaging apparatus 1A goes to Step S211 to be described later. In contrast, if the exposure start timing has not already been calculated (Step S210: No), the imaging apparatus 1A goes to Step S212 to be described later.

At Step S211, the exposure control unit 384A identifies, in the regions identified by the region identifying unit 383A, a color that has a largest difference between the maximum value and the minimum value with respect to changes in the output values of the three primary colors (R, G, B) of light, postpones the exposure start timing of the image sensor 32 until a timing at which the center of the exposure period matches a center position of a distance between the first position corresponding to the minimum output value of the identified color in the first color unevenness occurrence region and the second position corresponding to the minimum output value of the identified color in the second color unevenness occurrence region, and causes the image sensor 32 to capture a still image. After Step S211, the imaging apparatus 1A goes to Step S214 to be described later.

At Step S212, the exposure control unit 384A causes the image sensor 32 to capture a still image at a normal timing. After Step S212, the imaging apparatus 1A goes to Step S214 to be described later.

At Step S213, the exposure control unit 384A causes the image sensor 32 to display the live view image on the display unit 41. After Step S213, the imaging apparatus 1A goes to Step S214 to be described below.

At Step S214, if an instruction signal for terminating image capturing is input from the operating unit 36 (Step S214: Yes), the imaging apparatus 1A terminates the process. In contrast, if the instruction signal for terminating image capturing is not input from the operating unit 36 (Step S214: No), the imaging apparatus 1A returns to Step S101 as described above.

According to the example as described above, the output value of a color for which the difference between the maximum output value and the minimum output value is large in the color unevenness occurrence region is used, so that it is possible to accurately determine the center position between the color unevenness occurrence regions.

Furthermore, according to the example, the center position between the color unevenness occurrence regions of the color for which the difference between the maximum output value and the minimum output value is large is adopted as a shutter median value (an exposure period median value), so that a start and an end of the exposure period are not included in the color unevenness occurrence region.

Moreover, according to the example, it is possible to avoid occurrence of color unevenness due to flicker in a captured image.

A first modification will be described below. In the example as described above, the avoidance timing for avoiding color unevenness is calculated by using only information on a color for which the difference between the maximum value and the minimum value is large among the pieces of RGB information; however, in the first modification, after selection of the information on the color for which the difference between the maximum value and the minimum value is large, the avoidance timing for avoiding color unevenness is calculated by further using the remaining pieces of color information. Meanwhile, the same components as those of the imaging apparatus 1A according to the example as described above will be denoted by the same reference symbols, and detailed explanation thereof will be omitted.

FIG. 18 is a diagram for schematically explaining the center position of the exposure period that is determined by the exposure control unit 384A according to the first modification. In FIG. 18, a horizontal axis represents the position of each of the regions in the vertical direction in the difference image, and a vertical axis represents an output value. Further, in FIG. 18, the curve L_{R3} represents the output value of R (red), the curve L_{G3} represents the output value of G (green), and the curve L_{B3} represents the output value of B (blue). More specifically, in FIG. 18, the horizontal axis represents the position of each of the regions from an upper side to a lower side in the vertical direction of the difference image, and a smaller number indicates an upper position.

As illustrated in FIG. 18, first, the exposure control unit 384A identifies, in the regions identified by the region identifying unit 383A, a color that has a largest difference between a maximum value and a minimum value with respect to changes in the output values of the three primary colors of light, determines, as the center position of the exposure period, a center position of a distance between the first positon corresponding to the minimum output value of the identified color in the first color unevenness occurrence region and the second position corresponding to the minimum output value of the identified color in the second color unevenness occurrence region, and controls exposure. In the case illustrated in FIG. 18, the exposure control unit 384A selects the B information as information on a first determination criterion.

Subsequently, the exposure control unit 384A acquires, as the avoidance timing, an intermediate point between two timings Q10 and Q11 or either one of the two timings Q10 and Q11 at which the output values are the closest to zero in the selected color information. Then, the exposure control unit 384A determines the avoidance timing as a candidate timing to be adopted as the center of the exposure period. Thereafter, the exposure control unit 384A calculates a sum of absolute values of pieces of the difference color information other than the first determination criterion with respect to the two candidate timings, and calculates a timing for which a result of the sum is closer to around zero that is a reference value, as the central timing of the exposure period. For example, a total value of the absolute values at the timing Q10 and the timing Q11 for the R information and the G information other than first determination criterion (the B information) is used.

Thereafter, the exposure control unit 384A determines the central timing of the exposure period as the avoidance timing for avoiding the color unevenness due to flicker, determines the avoidance timing as the center position of the exposure period, and controls exposure.

According to the first modification, the output value of a certain color for which the difference between the maximum output value and the minimum output value is large in the color unevenness non-occurrence region is used, so that it is possible to accurately determine the center position between the color unevenness occurrence regions.

Furthermore, according to the first modification, the center position between the color unevenness occurrence regions with respect to the color for which the difference between the maximum output value and the minimum output value is large is adopted as the shutter median value (the exposure period median value), so that the start and the end of the exposure period are not included in the color unevenness occurrence region.

Moreover, according to the first modification, it is possible to avoid occurrence of color unevenness due to flicker in a captured image.

A second modification will be described below. In the embodiment as described above, the avoidance timing for avoiding color unevenness is calculated by using only information on a color for which the difference between the maximum value and the minimum value is large among the pieces of RGB information; however, in the second modification, after selection of the information on the color for which the difference between the maximum value and the minimum value is large, the avoidance timing for avoiding color unevenness is calculated by further using the remaining pieces of color information. Meanwhile, the same components as those of the imaging apparatus 1A according to the example as described above will be denoted by the same reference symbols, and detailed explanation thereof will be omitted.

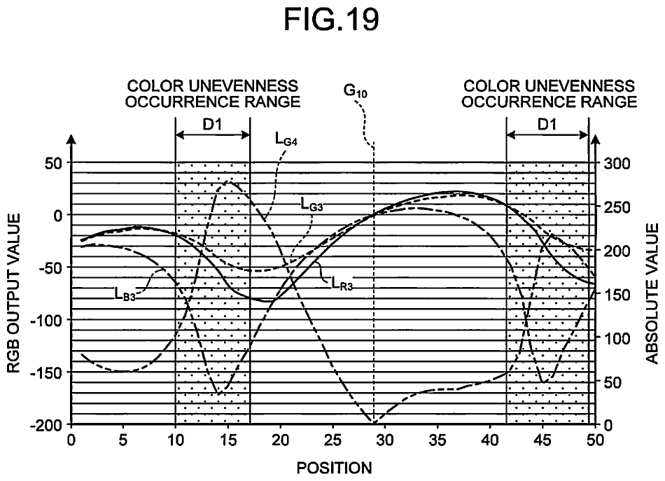

FIG. 19 is a diagram for schematically explaining the center position of the exposure period that is determined by the exposure control unit 384A. In FIG. 19, a horizontal axis represents the position of each of regions in the vertical direction in the difference image, and a vertical axis represents an output value. Further, in FIG. 19, the curve L_{R3} represents the output value of R (red), the curve L_{G3} represents the output value of G (green), and the curve L_{B3} represents the output value of B (blue). A curve L_{G4} represents a total value of absolute values of pieces of difference color information for all of the regions (refer to the right vertical axis). More specifically, in FIG. 19, the horizontal axis represents the position of each of the regions from an upper side to a lower side in the vertical direction of the difference image, and a smaller number indicates an upper position.

As represented by the curve L_{G4} in FIG. 19, first, the exposure control unit 384A calculates the total value of the absolute values of pieces of difference color information for all of the regions. Then, the exposure control unit 384A compares the total values of the absolute values of the pieces of difference color information for all of the regions, and calculates a position G10 at which the output value is the closest to a minimum value, in particular, zero, as a timing that is adopted as an intermediate point of the exposure period. Thereafter, the exposure control unit 384A determines the central timing of the exposure period as the avoidance timing for avoiding color unevenness due to flicker, determines the avoidance timing as the center position of the exposure period, and controls exposure.

According to the second modification as described above, it is possible to avoid occurrence of color unevenness due to flicker in a captured image.

Variations may be made by appropriately combining a plurality of constituent elements disclosed in the embodiment as described above. For example, some constituent elements may be deleted from all of the constituent elements described in the embodiment as described above. Furthermore, the constituent elements described in the embodiment as described above may be appropriately combined.

Furthermore, in the embodiment, the “unit” described above may be replaced with a “means”, a “circuit”, or the like. For example, the control unit may be replaced with a control means or a control circuit.

Moreover, the programs to be executed by the imaging apparatus according to the embodiment are provided by being recorded, as file data in an installable format or executable format, on a computer readable recording medium such as a compact disk read only memory (CD-ROM), a flexible disk (FD), a compact disk recordable (CD-R), a digital versatile disk (DVD), a universal serial bus (USB) medium, or a flash memory.

Furthermore, the programs to be executed by the imaging apparatus according to the embodiment may be stored on a computer connected to a network, such as the Internet, and provided by downloaded via the network. Moreover, the programs to be executed by the imaging apparatus according to the embodiment may be provided or distributed via a network, such as the Internet.

In describing the flowcharts in this specification, context of the processes among the steps is disclosed by using expressions such as “first”, “thereafter”, and “subsequently”, but the sequences of the processes necessary for carrying out the present disclosure are not uniquely defined by these expressions. In other words, the sequences of the processes in the flowcharts described in the present specification may be modified as long as there is no contradiction. Furthermore, the processes need not always be implemented by simple branch processing, but may be branched based on comprehensive determination on the increased number of determination items. In this case, it may be possible to additionally use an artificial intelligence technique that realizes machine learning by repetition of learning by requesting a user to perform manual operation. Moreover, it may be possible to perform learning of operation patterns that are implemented by a large number of specialists, and perform the processes by deep learning with further inclusion of complicated conditions.

While some embodiments of the present application have been explained in detail above based on the drawings, the embodiments are described by way of example, and the present disclosure may be embodied in various other forms with various changes or modifications based on knowledge of a person skilled in the art, in addition to the embodiments described in this specification.

The present disclosure may also be configured as described below.

(1) An imaging apparatus including:

a detection unit that detects a flicker cycle of a light source from an incident light that enters an image sensor used for multi-zone metering;

a region dividing unit that generates a difference image between an image in which a light intensity fringe is not present and an image in which a light intensity fringe is present based on the flicker cycle, and divides the difference image into a plurality of regions along an image reading direction of the image sensor;

a region identifying unit that identifies, from among the plurality of divided regions, a first color unevenness occurrence region, a second color unevenness occurrence region, and a color unevenness non-occurrence region located between the first color unevenness occurrence region and the second color unevenness occurrence region; and

an exposure control unit that identifies, in the identified regions, a color that has a largest difference between a maximum value and a minimum value with respect to changes in output values of three primary colors (R, G, B) of light, determines, as a center position of an exposure period, a center position of a distance between a first positon corresponding to a minimum output value of the identified color in the first color unevenness occurrence region and a second position corresponding to a minimum output value of the identified color in the second color unevenness occurrence region, and controls exposure.

According to (1), the output value of the color for which the difference between the maximum output value and the minimum output value is large in the color unevenness occurrence region is used, so that it is possible to accurately determine the center position between the color unevenness occurrence regions.

Furthermore, according to (1), the center position between the color unevenness occurrence regions of the color for which the difference between the maximum output value and the minimum output value is large is adopted as the shutter median value, so that the start and the end of the exposure period are not included in the color unevenness occurrence region.

(2) The imaging apparatus according to (1), wherein the first color unevenness occurrence region and the second color unevenness occurrence region are identified based on color information on each of the regions.

(3) A method for reducing color unevenness due to flicker, the method including:

a detection step of detecting a flicker cycle of a light source from an incident light that enters an image sensor used for multi-zone metering;

a region dividing step of generating a difference image between an image in which a light intensity fringe is not present and an image in which a light intensity fringe is present based on the flicker cycle, and dividing the difference image into a plurality of regions along an image reading direction of the image sensor;

a region identifying step of identifying, from among the plurality of divided regions, a first color unevenness occurrence region, a second color unevenness occurrence region, and a color unevenness non-occurrence region located between the first color unevenness occurrence region and the second color unevenness occurrence region; and

an exposure control step of identifying, in the identified regions, a color that has a largest difference between a maximum value and a minimum value with respect to changes in output values of three primary colors (R, G, B) of light, determining, as a center position of an exposure period, a center position of a distance between a first positon corresponding to a minimum output value of the identified color in the first color unevenness occurrence region and a second position corresponding to a minimum output value of the identified color in the second color unevenness occurrence region, and controlling exposure.

Meanwhile, the three primary colors of light are red, green, and blue.

(4) A program that is executed by an imaging apparatus for reducing color unevenness due to flicker, the program causing the imaging apparatus to execute:

a detection step of detecting a flicker cycle of a light source from an incident light that enters an image sensor used for multi-zone metering;

a region dividing step of generating a difference image between an image in which a light intensity fringe is not present and an image in which a light intensity fringe is present based on the flicker cycle, and dividing the difference image into a plurality of regions along an image reading direction of the image sensor;

a region identifying step of identifying, from among the plurality of divided regions, a first color unevenness occurrence region, a second color unevenness occurrence region, and a color unevenness non-occurrence region located between the first color unevenness occurrence region and the second color unevenness occurrence region; and

an exposure control step of identifying, in the identified regions, a color that has a largest difference between a maximum value and a minimum value with respect to changes in output values of three primary colors (R, G, B) of light, determining, as a center position of an exposure period, a center position of a distance between a first positon corresponding to a minimum output value of the identified color in the first color unevenness occurrence region and a second position corresponding to a minimum output value of the identified color in the second color unevenness occurrence region, and controlling exposure.

(5) An imaging apparatus including:

a detection unit that detects a flicker cycle of a light source from an incident light that enters an image sensor used for multi-zone metering;

a region dividing unit that generates a difference image between an image in which a light intensity fringe is not present and an image in which a light intensity fringe is present based on the flicker cycle, and divides the difference image into a plurality of regions along an image reading direction of the image sensor;

a region identifying unit that identifies, from among the plurality of divided regions, a first color unevenness occurrence region, a second color unevenness occurrence region, and a color unevenness non-occurrence region located between the first color unevenness occurrence region and the second color unevenness occurrence region; and

an exposure control unit that identifies, in the identified regions, a color that has a largest difference between a maximum value and a minimum value with respect to changes in output values of three primary colors of light, determines, as a center position of an exposure period, a center position of a distance between a first positon corresponding to a minimum output value of the identified color in the first color unevenness occurrence region and a second position corresponding to a minimum output value of the identified color in the second color unevenness occurrence region, and controls exposure.

According to (5), the output value of the color for which the difference between the maximum output value and the minimum output value is large in the color unevenness occurrence region is used, so that it is possible to accurately determine a center position between the color unevenness occurrence regions.

Furthermore, according to (5), the center position between the color unevenness occurrence regions of the color for which the difference between the maximum output value and the minimum output value is large is adopted as the shutter median value, so that the start and the end of the exposure period are not included in the color unevenness occurrence region.

(6) The imaging apparatus according to (5), wherein the first color unevenness occurrence region and the second color unevenness occurrence region are identified based on color information on each of the regions.

(7) A method for reducing color unevenness due to flicker, the method including:

a detection step of detecting a flicker cycle of a light source from an incident light that enters an image sensor used for multi-zone metering;

a region dividing step of generating a difference image between an image in which a light intensity fringe is not present and an image in which a light intensity fringe is present based on the flicker cycle, and dividing the difference image into a plurality of regions along an image reading direction of the image sensor;

a region identifying step of identifying, from among the plurality of divided regions, a first color unevenness occurrence region, a second color unevenness occurrence region, and a color unevenness non-occurrence region located between the first color unevenness occurrence region and the second color unevenness occurrence region; and

an exposure control step of identifying, in the identified regions, a color that has a largest difference between a maximum value and a minimum value with respect to changes in output values of three primary colors of light, determining, as a center position of an exposure period, a center position of a distance between a first positon corresponding to a minimum output value of the identified color in the first color unevenness occurrence region and a second position corresponding to a minimum output value of the identified color in the second color unevenness occurrence region, and controlling exposure.

(8) A program that is executed by an imaging apparatus for reducing color unevenness due to flicker, the program causing the imaging apparatus to execute:

a detection step of detecting a flicker cycle of a light source from an incident light that enters an image sensor used for multi-zone metering;

a region dividing step of generating a difference image between an image in which a light intensity fringe is not present and an image in which a light intensity fringe is present based on the flicker cycle, and dividing the difference image into a plurality of regions along an image reading direction of the image sensor;

a region identifying step of identifying, from among the plurality of divided regions, a first color unevenness occurrence region, a second color unevenness occurrence region, and a color unevenness non-occurrence region located between the first color unevenness occurrence region and the second color unevenness occurrence region; and

an exposure control step of identifying, in the identified regions, a color that has a largest difference between a maximum value and a minimum value with respect to changes in output values of three primary colors of light, determining, as a center position of an exposure period, a center position of a distance between a first positon corresponding to a minimum output value of the identified color in the first color unevenness occurrence region and a second position corresponding to a minimum output value of the identified color in the second color unevenness occurrence region, and controlling exposure.

According to the present disclosure, it is possible to acquire an avoidance timing for avoiding occurrence of color unevenness due to flicker in a captured image.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general concept as defined by the appended claims and their equivalents.

What is claimed is:

1. An imaging apparatus comprising:
a processor configured to
detect a flicker cycle of a light source from an incident light that enters an image sensor used for multi-zone metering;
generate a difference image between an image in which a light intensity fringe is not present and an image in which a light intensity fringe is present based on the flicker cycle;
divide the difference image into a plurality of regions along an image reading direction of the image sensor;
identify, from among the plurality of divided regions, a first color unevenness occurrence region including a portion in which a light intensity waveform decreases, a second color unevenness occurrence region including a portion in which the light intensity waveform decreases, and a color unevenness non-occurrence region in which the light intensity waveform increases from the first color unevenness occurrence region to the second color unevenness occurrence region;
determine a center position of an exposure period in the identified color unevenness non-occurrence region, and controls exposure; and
control exposure such that, in a direction perpendicular to an image reading direction of an image sensor, the center position of the exposure period located in the color unevenness non-occurrence region satisfying conditions 1 to 3 below:
condition 1: located at a position at which the exposure period does not include the first color unevenness occurrence region and the second color unevenness occurrence region at time of exposure;
condition 2: located at a position at which the exposure period does not include a minimum light intensity position at a side of the first color unevenness occurrence region in the color unevenness non-occurrence region; and
condition 3: located at a position at which the exposure period does not include a peak intensity position at a side of the second color unevenness occurrence region in the color unevenness non-occurrence region.

2. The imaging apparatus according to claim 1, wherein the center position of the exposure period is located in a middle of a distance between the first color unevenness occurrence region and the second color unevenness occurrence region, from the first color unevenness occurrence region toward the second color unevenness occurrence region.

3. The imaging apparatus according to claim 2, wherein the processor is configured to identify the first color unevenness occurrence region and the second color unevenness occurrence region based on a maximum value and a minimum value of luminance values in each of the regions.

4. A method for reducing color unevenness, comprising:
detecting a flicker cycle of a light source from an incident light that enters an image sensor used for multi-zone metering;
generating a difference image between an image in which a light intensity fringe is not present and an image in which a light intensity fringe is present based on the flicker cycle;
dividing the difference image into a plurality of regions along an image reading direction of the image sensor;
identifying, from among the plurality of divided regions, a first color unevenness occurrence region including a portion in which a light intensity waveform decreases, a second color unevenness occurrence region including a portion in which the light intensity waveform decreases, and a color unevenness non-occurrence region in which the light intensity waveform increases from the first color unevenness occurrence region to the second color unevenness occurrence region;
determining a center position of an exposure period in the identified color unevenness non-occurrence region; and
controlling exposure such that, in a direction perpendicular to an image reading direction of an image sensor, the center position of the exposure period located in the color unevenness non-occurrence region satisfying conditions 1 to 3 below:
condition 1: located at a position at which the exposure period does not include the first color unevenness occurrence region and the second color unevenness occurrence region at time of exposure;
condition 2: located at a position at which the exposure period does not include a minimum light intensity position at a side of the first color unevenness occurrence region in the color unevenness non-occurrence region; and
condition 3: located at a position at which the exposure period does not include a peak intensity position at a side of the second color unevenness occurrence region in the color unevenness non-occurrence region.

5. The method according to claim 4, wherein the center position of the exposure period is located in a middle of a distance between the first color unevenness occurrence region and the second color unevenness occurrence region, from the first color unevenness occurrence region toward the second color unevenness occurrence region.

6. The method according to claim 5, wherein the identifying identifies the first color unevenness occurrence region and the second color unevenness occurrence region based on a maximum value and a minimum value of luminance values in each of the regions.

7. A non-transitory computer readable recording medium on which an executable program is recorded, the program instructing a processor to execute:
detecting a flicker cycle of a light source from an incident light that enters an image sensor used for multi-zone metering;
generating a difference image between an image in which a light intensity fringe is not present and an image in which a light intensity fringe is present based on the flicker cycle;
dividing the difference image into a plurality of regions along an image reading direction of the image sensor;
identifying, from among the plurality of divided regions, a first color unevenness occurrence region including a portion in which a light intensity waveform decreases, a second color unevenness occurrence region including a portion in which the light intensity waveform decreases, and a color unevenness non-occurrence region in which the light intensity waveform increases from the first color unevenness occurrence region to the second color unevenness occurrence region;
determining a center position of an exposure period in the identified color unevenness non-occurrence region; and
controlling exposure such that, in a direction perpendicular to an image reading direction of an image sensor, the center position of the exposure period located in the color unevenness non-occurrence region satisfying conditions 1 to 3 below:
condition 1: located at a position at which the exposure period does not include the first color unevenness occurrence region and the second color unevenness occurrence region at time of exposure;
condition 2: located at a position at which the exposure period does not include a minimum light intensity position at a side of the first color unevenness occurrence region in the color unevenness non-occurrence region; and
condition 3: located at a position at which the exposure period does not include a peak intensity position at a side of the second color unevenness occurrence region in the color unevenness non-occurrence region.

8. The non-transitory computer readable recording medium according to claim 7, wherein the center position of the exposure period is located in a middle of a distance between the first color unevenness occurrence region and the second color unevenness occurrence region, from the first color unevenness occurrence region toward the second color unevenness occurrence region.

9. The non-transitory computer readable recording medium according to claim 8, wherein the program instructs the processor to execute identify the first color unevenness occurrence region and the second color unevenness occurrence region based on a maximum value and a minimum value of luminance values in each of the regions.
